(19) United States
(12) Patent Application Publication
(10) Pub. No.: US 2025/0157020 A1
(43) Pub. Date: May 15, 2025

(54) METHOD FOR DETECTING DEFECTS ON AN AERONAUTICAL PART

(71) Applicant: SAFRAN, PARIS (FR)

(72) Inventor: Héléna VOROBIEVA, MOISSY CRAMAYEL (FR)

(21) Appl. No.: 18/838,297

(22) PCT Filed: Jan. 24, 2023
(86) PCT No.: PCT/FR2023/050093

§ 371 Date: Aug. 14, 2024

(30) Foreign Application Priority Data
Feb. 16, 2022 (FR) 2201348

(51) Int. Cl. G06T 7/00; G06V 10/75; G06V 10/82

(52) U.S. Cl. CPC G06T 7/0004; G06V 10/751; G06V 10/82; G06T 2207/20021; G06T 2207/20081; G06T 2207/20084

(57) ABSTRACT

A method for detecting defects for an aeronautical part, includes training, during a plurality of epochs, an artificial neural network to supply a defect probability for each pixel of an image, for each epoch and for each image of a validation set, creating a defect probability matrix based on defect probabilities for each pixel of the image, for each epoch, determining, for each image of the validation set, based on the defect probability matrices, a curve of defect detection as a function of false alarms, determining a set of the N best epochs on the basis of the defect detection curves and of a business criterion, for each epoch of the N best epochs, inspecting the image to be inspected by applying the artificial neural network with parameters associated with the epoch, so as to obtain an inspected sub-image associated with the training epoch.

### TECHNICAL FIELD OF THE INVENTION

The technical field of the invention is that of defect detection, and more particularly that of automatic detection of defects on an aeronautical part.

### TECHNOLOGICAL BACKGROUND OF THE INVENTION

For the purpose of automatically detecting presence of defects on an aeronautical part, i.e. to indicate whether defects are present on the aeronautical part and their approximate location, while limiting false alarms, i.e. without indicating the presence of defects when none are present, in order to avoid the part being discarded, examined by hand, or given for inspection to another system that is more costly in terms of computing power or time, it is known to carry out non-destructive testing on the part using an algorithm on one or more images of the part.

When the aeronautical part is of a complex shape, which is for example the case for engine vanes, each image is divided into several sub-images and testing is carried out for each sub-image. Two strategies are then possible for finding defects, either a classification strategy consisting in indicating whether the sub-image includes a defect, or a semantic segmentation strategy consisting in indicating, on each sub-image, pixels included in a defect zone.

It is known to carry out non-destructive testing of the part using an artificial neural network which calculates a prediction corresponding to a probability that the part is defective.

In order to gain in robustness, it is also known to use several artificial neural networks and to merge their predictions by calculating, for example, mean of the predictions. The artificial neural networks used have different architectures, or the same architecture but different initialisation.

Another way of gaining in robustness is to use ensemble methods on a single artificial neural network but taken at different training epochs, which has the advantage of only training a single artificial neural network. The epochs are selected, for example, according to the cost function used for training the artificial neural network, which is detrimental to misclassified sub-images or pixels.

Other indicators conventionally used to measure detection or semantic segmentation performance could also be used, for example the Mean Intersection over Union (mIoU) corresponding to the area of overlap of the predicted class with the ground truth class over the total area of the union of the predicted class and the ground truth class, the accuracy corresponding to the percentage of pixels or sub-images of the class correctly predicted out of all the predictions of this class, or the recall corresponding to the percentage of pixels or sub-images of the class found out of the ensemble of pixels or sub-images of the class.

Regardless of whether it is the cost function or the conventionally used indicators mentioned above, these measures do not enable presence of defects on an aeronautical part to be detected with as few false alarms as possible. Indeed, these measures will be very detrimental if, for example, only some of the pixels in a defective zone are classified as defects, whereas the presence of a defect and its approximate location have been detected, as desired. Similarly, if an extensive defect zone is found on several sub-images, it would be sufficient to classify only some of these sub-images as defects, whereas the measures will be detrimental to the other misclassified sub-images in this zone. Symmetrically, for healthy zones, it is identical, given the objective, to return an aggregation of misclassified healthy pixels or sub-images regardless of the size of the aggregation, whereas the measures will be more detrimental for larger aggregations.

Thus, measures of the state of the art are not adapted to select the best epochs within the framework of ensemble methods for automatic detection of the presence of defects on an aeronautical part with a reduced number of false alarms.

### SUMMARY OF THE INVENTION

The invention offers a solution to the problems discussed previously, by making it possible to detect presence of defects on an aeronautical part via an ensemble method using optimal epochs for training an artificial neural network, making it possible to limit number of false alarms.

A first aspect of the invention relates to a defect detection method for an aeronautical part from at least one image to be tested of the aeronautical part subdivided into a plurality of sub-images, the method comprising the following steps of:
Supervisedly training, for a plurality of training epochs, an artificial neural network configured to provide a defect probability for each pixel of a training sub-image of a training image,
For each training epoch and for each image of a validation set, creating a defect probability matrix from merging defect probabilities determined for each pixel of each sub-image of the image of the validation set,
For each training epoch, determining, from the defect probability matrices associated with said training epoch, a defect detection curve as a function of false alarms,
Determining an ensemble of the N best training epochs of the plurality of training epochs as a function of the defect detection curves as a function of false alarms and a criterion in the field, N being an integer greater than or equal to 1,
For each training epoch of the N best epochs, applying, to each sub-image of the image to be tested, the artificial neural network with parameters associated with said epoch, in order to obtain a tested sub-image associated with said training epoch,
For each sub-image of the image to be tested, merging the N tested sub-images to obtain probabilities of the presence of a defect on the sub-image.

By a “criterion in the field”, it is meant a curve selection criterion which is based on the knowledge of the user of the method according to the invention and/or as a function of the application related to the method according to the invention. It may, for example, be a criterion based on the area under the curves, a detection density in the curves, a detection pattern such as a high detection density followed by a low detection density, regularity of the curves, etc.

By “defect”, it is meant a discontinuity in the properties of the material making up a part or object being inspected, herein the aeronautical part. This discontinuity results from an anomaly present in the material. This anomaly can have various origins and be of a varied nature. Most of these anomalies are the result of hazards that occur upon manufacturing the part. These anomalies also quite frequently occur upon using or handling the part: the material may, for example, have been embrittled during the manufacturing process and its use, generating high local stresses in the embrittled zone, or following an impact, generates a defect. The term “defect” therefore covers all forms of anomaly to which the material may be subjected-material defect, inclusion, crack, porosity, corrosion, impairment in the material properties, etc.

By a defect detection curve as a function of false alarms, it is meant an ensemble of connected points with the number of false alarms on the abscissa (which can range from 0 to infinity) and the number of correctly detected defects on the ordinate (which can range from 0 to the total number of defects to be detected, which can be zero in some cases).

By virtue of the invention, the possible presence of defects is detected on each sub-image making up an image of the aeronautical part, by merging the results obtained using an artificial neural network taken at several training epochs. These epochs have been selected beforehand to detect the approximate location of each defect while limiting the number of false alarms. For this, for each selectable epoch, a results matrix is reconstituted for each image of a validation database from the results provided by the artificial neural network trained during the training epochs for each sub-image making up the image, which makes it possible to obtain an image-wide view of the defects and thus remove some of the bias introduced by splitting into sub-images. A curve representing the number of detections as a function of the number of false alarms is then determined for each epoch. It is then possible to select an ensemble of curves according to a criterion in the field. This enables curves to be selected to meet performance criteria in order to select optimum training epochs for defect detection by minimising the number of false alarms.

The approaches of the state of the art only estimate performance of the neural network on the images or sub-images that have been input to the neural network. Furthermore, in the state of the art, the best training epochs are always determined by virtue of these performance calculated on what is input to the neural network, i.e. the images or sub-images. In other words, in the state of the art, performance is calculated on training, validation or test sets of images, or sub-images, in order to evaluate performance of the neural network on the images or sub-images, respectively. In contrast, in the present invention, performance on images is calculated by calculating performance on sub-images. Indeed, the neural network is configured to learn and predict on sub-images, and then the data output from the neural network are used to evaluate performance of the neural network on the images from which the sub-images originate. According to the invention, performance on the images is therefore not calculated directly but indirectly by calculating performance on the sub-images.

Further to the characteristics just discussed in the previous paragraph, the method according to the invention may have one or more additional characteristics from among the following, considered individually or according to any technically possible combinations.

According to one alternative embodiment, the supervised training is carried out, for the plurality of epochs, from a training database, the number of training epochs of the plurality of training epochs being determined by a stop criterion, each training epoch of the plurality of training epochs being associated with a number, the training database comprising a plurality of sub-images for each of a plurality of training images of aeronautical parts, each sub-image being associated with defect information for each pixel of the sub-image.

A “stop criterion” is a criterion that provides information about the condition(s) to cease the artificial neural network learning process. This may, for example, be a predefined maximum number of training epochs, a stop threshold to be reached for the cost function of the artificial neural network, the detection of overlearning, etc.

According to one alternative embodiment, the step of creating a defect probability matrix associated with each training epoch and associated with each image of the validation set is performed according to the following sub-steps of:
For each sub-image of the image of the validation set, using, on the sub-image, the artificial neural network with the parameters associated with said epoch, to obtain a defect probability for each pixel of the sub-image,
associating with each pixel of the image of the validation set, a pixel defect probability calculated from merging each defect probability obtained for the pixel.

According to one alternative embodiment, the step of determining a defect detection curve as a function of the false alarms associated with a training epoch is carried out according to the following sub-steps of:
For each threshold of a plurality of thresholds included in a predefined threshold interval, and for each image of the validation set:
   Thresholding the defect probability matrix associated with said image and said epoch by the threshold;
   For each ensemble of adjacent pixels of said image of the validation set comprising only pixels associated with a non-zero pixel defect probability in the thresholded defect probability matrix associated with the image:
      If no pixel in the ensemble of pixels is associated with non-zero defect information in the validation set, incrementing a number of false alarms associated with the threshold;
   For each ensemble of adjacent pixels of non-zero defect information in the validation set, if at least one pixel in the thresholded defect probability matrix is associated with a non-zero pixel defect probability, incrementing a number of detections associated with the threshold;
Plotting a curve, associated with said epoch, representing the number of detections as a function of the number of false alarms, including one point per threshold, corresponding to the number of detections and the number of false alarms associated with the threshold.

Each result matrix obtained is thresholded with several thresholds to take account of a diversity of operating points for each epoch, and in each thresholded result matrix, the ensembles of adjacent non-zero pixels are compared with the corresponding defect information to calculate the number of detections and the number of false alarms, independently of the number of pixels included in the detection and the size of the false alarm.

According to one alternative embodiment, for each training epoch among the ensemble of N best training epochs, the test result of a sub-image is a matrix, each coefficient of which corresponds to a defect probability for each pixel of the sub-image.

According to one alternative embodiment, the artificial neural network is configured to provide, from a sub-image, a defect probability per pixel of the sub-image, each sub-image of the training database and each sub-image of the validation database being associated with defect information per pixel of the sub-image.

Thus, the artificial neural network is trained and tested to perform a semantic segmentation task.

According to one alternative embodiment, the artificial neural network is configured to provide, from a sub-image, a defect probability for the ensemble of pixels of the sub-image, each sub-image of the training database and each sub-image of the validation database being associated with defect information for the ensemble of pixels of the sub-image.

Thus, the artificial neural network is trained and tested to perform a classification task.

According to one alternative embodiment complementary to the preceding alternative embodiment, the step of determining the defect detection curve further comprises a correction step by deleting each point corresponding to a threshold for which the number of false alarms associated with the threshold is less than the number of false alarms associated with the immediately following threshold in the predefined threshold interval following the Plotting step, the deletion step being repeated at each deleted point starting from the lowest remaining threshold.

Thus, curves are corrected for aberrant behaviour in the number of false alarms when the detection threshold applied does not allow regions of the image with a detected defect to be correctly distinguished from those with a false alarm. In particular, this makes it possible to correct curves when the number of false alarms decreases as the threshold value decreases.

According to one alternative embodiment, the corrected curve is normalised by adding an initial point associated with a zero number of detections and a zero number of false alarms and adding a final point associated with the maximum number of detections of the corrected curve and a predefined maximum number of false alarms, following the correction step.

Thus, all the curves are first corrected and normalised to make all the curves comparable with each other. The area under each normalised curve is then calculated as a measure of performance of the artificial neural network for the given epoch number and used to select a predefined number of optimal epoch numbers for the application in question, namely the detection of the presence of defects minimising the number of false alarms.

According to one alternative embodiment, the thresholded defect probability matrix is smoothed.

Thus, for example, clusters of adjacent pixels not exceeding a predefined size are removed and, for example, small holes in the clusters of adjacent pixels are plugged.

According to one alternative embodiment, the criterion in the field for determining an ensemble of the N best training epochs of the plurality of training epochs as a function of the defect detection curves is the area under the curve.

According to one alternative embodiment, detecting a defect for an image to be tested is made by:
For each of these epochs and for each sub-image of the sub-divided image to be tested, using on the sub-image, the artificial neural network with the ensemble of parameters associated with said epoch, to obtain a defect probability for each pixel of the sub-image;
For each pixel of each sub-image of the sub-divided image to be tested, merging the defect probabilities obtained for the pixel for each epoch corresponding to a selected curve, to obtain a defect prediction for the sub-image.

According to one alternative embodiment, each pixel of an image is associated with a position in the image and the step of creating the defect probability matrix for an image is further performed from the position associated with each pixel of the image.

Thus, the defect probability matrix corresponds to the image in the validation database in which the colour or grey level information associated with each pixel is replaced with the pixel defect probability.

According to one alternative embodiment, when creating the defect probability matrix for an image, for each pixel of the image associated with a plurality of defect probabilities, the plurality of defect probabilities associated with the pixel is merged.

Thus, for each pixel belonging to an overlap zone between several sub-images, the pixel defect probability associated with the pixel takes account of the defect probability obtained for the pixel for each sub-image.

According to one alternative embodiment, the defect probabilities for each sub-image of the image to be tested obtained at the end of the step are merged in order to obtain defect probabilities for the image to be tested.

According to one alternative embodiment, the criterion in the field for selecting an ensemble of curves is a predetermined number of curves corresponding to the number of curves with the highest area under the curve.

According to one alternative embodiment, the artificial neural network is configured to provide, from a sub-image, a defect probability for the ensemble of pixels of the sub-image, each sub-image of the training database and each sub-image of the validation database being associated with defect information for the ensemble of pixels of the sub-image.

Thus, the artificial neural network is trained and tested to perform a classification task. In this case, all the coefficients of the result matrix associated with the sub-image will be equal to the defect probability provided by the network for this sub-image.

According to one alternative embodiment compatible with the preceding alternative embodiments, the defect probabilities obtained for a pixel are merged by averaging the defect probabilities obtained for the pixel.

Another aspect of the invention relates to a computer program product comprising instructions which, when the program is executed on a computer, cause the same to implement the steps of the method according to the invention.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 shows a schematic representation of an image of aeronautical part used by a method according to the invention.

FIG. 2 is a block diagram illustrating the sequence of steps of the method according to the invention.

FIG. 3 represents two curves obtained at the end of an eighth step of the method according to the invention.

FIG. 4 represents two examples of curves obtained by means the method according to the invention.

### DETAILED DESCRIPTION

Unless otherwise specified, a same element appearing in different figures has a single reference.

The invention relates to a method for detecting defects on an aeronautical part to be tested.

Defect detection is automatic, i.e. it does not require any human intervention during the final phase of use of the system, and is carried out from one or more images of the aeronautical part, for example taken from different viewing angles.

Each image of the aeronautical part is acquired beforehand by a camera and may be in colour or grey scale.

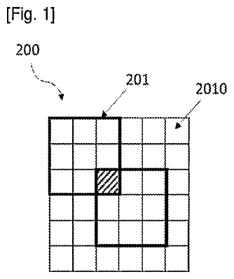

FIG. 1 shows a schematic representation of the image 200 of the aeronautical part.

The image 200 of the aeronautical part includes an ensemble of pixels 2010 and is subdivided into a plurality of sub-images 201 each including a sub-ensemble of pixels 2010 of the ensemble of pixels 2010.

FIG. 1 represents an image 200 including an ensemble of 36 pixels 2010. The plurality of sub-images 201 may or may not have overlapping zones

between them.

In FIG. 1, two sub-images 201 are represented, each including a sub-ensemble of 9 pixels and overlapping on a pixel 2010 represented as hatched lines.

The aeronautical part is preferably complex in shape, such as an engine vane, different types of vane root attachment, an aircraft fairing, etc.

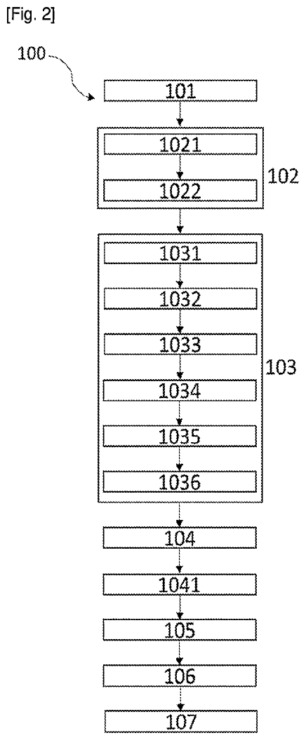

FIG. 2 is a block diagram illustrating the sequence of steps of the method 100 according to the invention.

A first step 101 of the method 100 according to the invention consists in supervisedly training an artificial neural network on a training database, in order to obtain an artificial neural network capable of providing, from a sub-image 201, a defect probability for each pixel 2010 of the sub-image 201.

The defect probability associated with a pixel 2010 expresses the probability that the pixel 2010 belongs to a defect and is between 0 and 1, or between 0 and 100% if it is expressed as a percentage.

Supervised training, otherwise known as supervised learning, makes it possible to train an artificial neural network for a predefined task, by updating its parameters in such a way as to minimise a cost function corresponding to the error between the output piece of data provided by the artificial neural network and the true output piece of data, i.e. what the artificial neural network should output in order to fulfil the predefined task from some input piece of data. Thus, depending on the neural network hyperparameters set at the start of training, each time a batch of M examples is provided to the artificial neural network, its parameters are updated. The hyperparameters are, for example, the number of layers in the network, the number of neurons per layer, the cost function to be optimised, the predefined parameters of the optimisation algorithm, etc. The parameters are, for example, the weights of the neurons.

A training database therefore includes input data, each associated with a real output piece of data.

The training database includes a plurality of images 200 of training aeronautical parts, each subdivided into a plurality of sub-images 201, each sub-image 201 being associated with defect information for each pixel 2010 of the sub-image 201.

Thus, the input data are the sub-images 201 and the true output data are the defect information for each pixel 2010 of the sub-image.

The defect information associated with a pixel 2010 is 0 if the pixel 2010 does not belong to a defect and 1 or 100% if the pixel 2010 belongs to a defect.

The training aeronautical parts are of the same type as the aeronautical part to be tested, i.e. if the aeronautical part to be tested is an aircraft engine vane, each training aeronautical part is also an aircraft engine vane.

The training database includes, for example, 200 images 200.

The artificial neural network can be trained for a classification task and then provides a single defect probability for the ensemble of pixels 2010 of the sub-image 201. Each sub-image 201 of the training database is then associated with defect information for the ensemble of pixels 2010 of the sub-image 201.

The artificial neural network trained for the classification task is, for example, a residual artificial neural network ResNet.

The artificial neural network can also be trained for a semantic segmentation task and then provides a defect probability per pixel 2010 of the sub-image 201. Each sub-image 201 of the training database is then associated with a defect information per pixel 2010 of the sub-image 201.

The artificial neural network trained for the semantic segmentation task is, for example, the artificial neural network LinkNet, U-Net or FDNN.

The artificial neural network is trained by performing a number of epochs on the training database, for example until a predefined stop criterion is satisfied. For example, a stop criterion could be a predefined number of epochs, for example 200 epochs. Another example would be to train the network for a given time, for example one week. Another example would be to train the network until overlearning occurs on the validation set (for example, the cost function continues to decrease on the training set, but starts to increase during a predefined number of epochs on the validation set).

By “the training of an artificial neural network is carried out by performing N epochs on a database including M data”, it is meant the following iterative process: during the first epoch the M data of the training database are provided (taken in order or randomly), during the second epoch the M data of the training database are provided (taken in the same order or randomly with respect to the previous epoch), . . . , at the nth epoch, the M data from the training database are provided (taken in the same order or randomly with respect to the previous epoch). Thus, the M data of the input database of the artificial neural network are provided N times during its training, each of the M data being provided only once during each of the epochs.

The plurality of epoch numbers includes, for example, each epoch number performed up to the stop condition, i.e. if the stop condition is triggered at epoch number 300, the plurality of epoch numbers includes, for example, each epoch number between 1 and 300.

The hyperparameters and parameters of the artificial neural network have, for example, been saved at the end of each training epoch in the first step 101.

A second step 102 of the method 100 according to the invention is performed for each training epoch, and for each image of a validation set V1, each image 200 of the validation set V1 being subdivided into a plurality of sub-images 201. By validation set, it is meant a database of validation images 200, the validation images 200 being used to validate training during the second step 102 of the method 100 according to the invention.

The validation database includes a plurality of images 200 of validating aeronautical parts, each subdivided into a plurality of sub-images 201, each validation sub-image 201 being associated with defect information for each pixel 2010 of the sub-image 201.

The validation aeronautical parts are of the same type as the aeronautical part to be tested.

The validation database includes, for example, 200 validation images 200.

In the case where the artificial neural network is trained for a classification task, each sub-image 201 of the validation image database is then associated with defect information for the ensemble of pixels 2010 of the sub-image 201.

In the case where the artificial neural network is trained for a semantic segmentation task, each sub-image 201 of the validation image database is then associated with defect information per pixel 2010 of the sub-image 201.

The second step 102 of the method 100 according to the invention consists, for each training epoch and for each image 200 of the validation set V1, in creating a defect probability matrix from merging the defect probabilities determined for each pixel 2010 of each sub-image 201 of the image 200 of the validation set, the defect probabilities being determined in a substep 1021 by applying the artificial neural network to each sub-image 201 of the image 200 of the validation set, the artificial neural network being applied with parameters associated with said training epoch.

In the second step 102, each pixel 2010 of each sub-image 201 of the validation database, and thus each pixel 2010 of each validation image 200 of the validation image database, is for example associated with at least one defect probability provided by the trained artificial neural network.

A pixel 2010 may be associated with a plurality of defect probabilities if the pixel 2010 belongs to an overlap zone between several sub-images 201, as is the case for the hatched pixel 2010 in FIG. 1.

The defect probability matrix associates with each pixel 2010 of the validation image 200 in question, a pixel defect probability obtained from each defect probability associated with the pixel 2010 at the end of the second step 102 for the number of epochs in question.

For each pixel 2010 associated with a single defect probability at the end of the second step 102, the pixel defect probability is equal to the single associated defect probability.

For each pixel 2010 associated with a plurality of defect probabilities at the end of the second step 102, the second step includes, for example, a substep 1022 consisting in obtaining the pixel defect probability by merging the plurality of defect probabilities associated with the pixel 2010.

Merging is for example performed by calculating the mean of the plurality of defect probabilities associated with the pixel 2010. The defect probability matrix corresponds to the validation image 200 in which, for each pixel 2010, the colour or grey level information associated with the pixel 2010 is replaced with the pixel defect probability, i.e. the defect probability matrix is arranged as a function of the position associated with each pixel 2010 in the validation image 200.

The defect probability matrix can therefore be assimilated to a greyscale image in which a pixel defect probability equal to 0 is represented in black and a pixel defect probability equal to 1 or 100% is represented in white.

At the end of the second step 102, each validation image 200 in the validation database is associated with a defect probability matrix for the training epoch in question.

A third step 103 of the method 100 according to the invention consists, for each training epoch, in determining from the probability matrices calculated in step 102 associated with said epoch, a defect detection curve as a function of false alarms.

The step 103 of determining a detection curve, for each training epoch, may include a plurality of sub-steps.

The predefined threshold interval is equal to [0; 1] or to [0; 100] if the defect probabilities are expressed as a percentage.

The plurality of thresholds is for example chosen within the predefined threshold interval so that for example the plurality of thresholds are evenly spaced. In the case where the predefined threshold interval is equal to [0; 1], the plurality of thresholds is for example chosen from 0.1 to 0.9 in steps of 0.1, and therefore includes 9 thresholds. It is also possible to define the plurality of thresholds with intervals of variable size, especially if the curve greatly varies around some values, for example to be more representative of the criticality of the values. Furthermore, the plurality of thresholds can be defined as a function of criteria in the field.

A first sub-step 1031 of step 103 of the method 100 according to the invention consists, for each defect probability matrix obtained at the end of second step 102, in thresholding the defect probability matrix in question by the threshold in question, i.e. in replacing each pixel defect probability of the defect probability matrix less than or equal to the threshold with 0 and each pixel defect probability of the defect probability matrix strictly greater than the threshold with 1.

The thresholded defect probability matrix can therefore be assimilated to a binary image in which a pixel defect probability equal to 0 is represented in black and a pixel defect probability equal to 1 or 100% is represented in white.

At the end of the first sub-step 1031, each image 200 of the validation database is associated with a thresholded defect probability matrix for the number of epochs in question.

The method 100 according to the invention may include a step consisting, for each thresholded defect probability matrix obtained at the end of the first sub-step 1031, in smoothing the thresholded defect probability matrix in question, for example by morphological opening or closing operations.

A second sub-step 1032 of step 103 of the method 100 according to the invention is then performed. This sub-step 1032 consists in incrementing a number of false alarms associated with the threshold in question, the number of false alarms associated with the threshold initially being zero, each time a condition C1 is met, by applying it to each ensemble of adjacent pixels 2010 associated with a non-zero pixel defect probability after thresholding performed in the first sub-step 1031 and possibly smoothing performed subsequently. Condition C1 is satisfied if each pixel 2010 of the considered ensemble of adjacent pixels 2010 associated with a non-zero pixel defect probability after thresholding performed in the first sub-step 1031 and possibly smoothing performed subsequently is associated with zero defect information in the validation database. Each ensemble of adjacent pixels 2010 must, for example, have at least a connectivity of 4. Thus, for example, if 200 ensembles of adjacent pixels 2010 associated with a non-zero pixel defect probability are obtained in the entire validation database after thresholding performed in the first sub-step 1031 and possibly smoothing performed subsequently, and if the condition C1 is performed 100 times, at the end of the second sub-step 1032 the number of false alarms associated with the threshold in question will be 100.

A third sub-step 1033 of step 103 of the method according to the invention is then performed. This sub-step 1033 consists in incrementing a number of detections associated with the threshold in question, the number of detections associated with the threshold initially being zero, each time a condition C2 is met, by applying it to each ensemble of adjacent pixels 2010 associated with non-zero defect information in the validation database. Condition C2 is verified if at least one pixel of the considered ensemble of adjacent pixels associated with non-zero defect information in the validation database is also associated with a non-zero pixel defect probability after thresholding performed in the first sub-step 1031 and possibly smoothing performed subsequently. Each ensemble of adjacent pixels 2010 needs, for example, to have at least a connectivity of 4. Thus, if for example in the validation database there are 200 ensembles of adjacent pixels 2010 associated with non-zero defect information in the validation database and condition C2 is met 100 times, at the end of the third sub-step 1033 the number of detections associated with the threshold considered will be 100.

At the end of the second sub-step 1032 and the third sub-step 1033, each threshold is associated with a number of detections and a number of false alarms having been obtained from each defect probability matrix created for the epoch number in question.

A fourth sub-step 1034 of step 103 of the method 100 according to the invention consists in plotting, for the number of epochs considered, a curve representing the number of detections as a function of the number of false alarms.

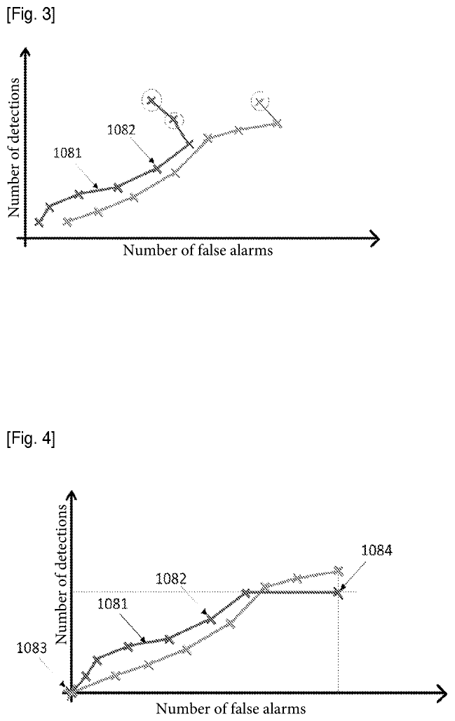

FIG. 3 represents a first curve 1081 and a second curve 1081 obtained at the end of the fourth sub-step 1034 for respectively a first training epoch number among the plurality of training epochs and a second training epoch number among the plurality of training epochs.

The curve 1081 includes one point 1082 per threshold considered, corresponding to the number of detections and the number of false alarms associated with the threshold obtained at the end of the second sub-step 1032 and the third sub-step 1033 of step 103 of the method 100 according to the invention.

In FIG. 3, the first curve 1081 and the second curve 1081 each include 8 points 1082.

According to a secondary embodiment, a fifth sub-step 1035 of step 103 of the method 100 according to the invention consists in correcting the curve 1081 obtained in the fourth sub-step 1034 for the number of epochs considered. The correction is performed by deleting each point 1082 corresponding to a

threshold for which the associated number of false alarms is less than the number of false alarms associated with the immediately following threshold in the predefined threshold interval (the nominal behaviour is that the number of false alarms decreases as the value of the threshold increases). The deletion process must thus be carried out iteratively, starting from the point corresponding to the lowest threshold. The deletion process is repeated from the lowest remaining threshold as soon as a point has been deleted, until no more points need to be deleted and considering the next threshold among the non-deleted thresholds.

For example, the plurality of thresholds may include a first threshold equal to 0.3 associated with a number F1 of false alarms, a second threshold equal to 0.6 associated with a number F2 of false alarms, a third threshold equal to 0.7 associated with a number F3 of false alarms, a fourth threshold equal to 0.8 associated with a number F4 of false alarms, and a fifth threshold equal to 0.9 associated with a number F5 of false alarms such that F4>F2>F1>F3>F5. Since the point 1082 associated with the first threshold has fewer false alarms than the point associated with the second threshold, the point associated with the first threshold is deleted. Thus, since a point has been deleted, the lowest remaining threshold point is chosen to repeat the deletion process. In this example, the lowest remaining threshold point is the point associated with the second threshold. As the point associated with the second threshold is associated with more false alarms than the point associated with the third threshold, it is not deleted. On the other hand, the point associated with the third threshold is associated with fewer false alarms than the point associated with the fourth threshold, so the point associated with the third threshold is deleted. Once a point has been deleted, the lowest remaining threshold point is chosen to start the deletion process again. The lowest remaining threshold point is the point associated with the second threshold. The point associated with the second threshold is associated with fewer false alarms than the point associated with the fourth threshold, so the point associated with the second threshold is deleted. Again, the lowest remaining threshold point is chosen to start the deletion process again. Herein, it is the point associated with the fourth threshold which is associated with more false alarms than the point associated with the fifth threshold. The fourth threshold is thus not deleted. As the fifth threshold is the largest threshold, it does not have a point associated with an immediately higher threshold, so it is not deleted.

In FIG. 3, the points 1082 that will be deleted from the first curve 1081 and the second curve 1082 during the correction step are circled.

According to a secondary embodiment, a sixth sub-step 1036 of step 103 of the method 100 according to the invention consists in normalising the corrected curve 1081 obtained in the fifth sub-step 1035 for the number of epochs considered.

FIG. 4 represents the first curve 1081 and the second curve 1081 of FIG. 3, obtained at the end of the sixth sub-step 1036.

Normalising is performed by adding to curve 1081 an initial point 1083 associated with a zero number of detections and a zero number of false alarms and a final point 1084 associated with the maximum number of detections of the corrected curve 1081 obtained in the fifth sub-step 1035 and with a predefined maximum number of false alarms.

The predefined maximum number of false alarms is for example equal to the maximum number of false alarms by comparing the curves obtained in the fourth step 1034 or in the fifth sub-step 1035 for each number of epochs considered.

At the end of the sixth sub-step 1036, a normalised curve 1081 is obtained for each epoch number of the plurality of epoch numbers.

A fourth step 104 of the method 100 according to the invention consists in determining a predefined number N of the best training epochs among the plurality of training epochs as a function of the defect detection curves 1081 and as a function of a criterion int the field.

Determining the N best epochs can be carried out by selecting N defect detection curves 1081 as a function of the criterion in the field. For example, selecting can be made automatically using a selection algorithm or by an operator. The criterion in the field for making the selection is, for example, based on the operator's knowledge and/or as a function of the application concerned. The criterion may be based on the area under the curves, a detection density in the curves, a detection pattern such as a high detection density then a low detection density, regularity of the curves, etc.

According to a secondary embodiment, a sub-step 1041 of the determination step 104 consists in calculating the area under each normalised curve 1081 obtained at the end of the sixth sub-step 1036 of step 103 of the method 100 according to the invention and in selecting a predefined number N of curves 1081 corresponding to the curves 1081 having the N highest calculated areas.

N is for example comprised between 2 and 50.

At the end of the fourth step 104, the N best epochs corresponding to the N selected curves have been determined and selected. By determining an epoch, it is meant selecting the state of the network at this epoch. N sets of known parameters associated with the N epochs which can be loaded into the network a posteriori are thus obtained.

A fifth step 105 of the method 100 according to the invention is performed for each training epoch of the ensemble of N best training epochs.

The fifth step 105 consists, for each training epoch of the ensemble of the number N of best epochs, in an application 105, to each sub-image 201 of the image 200 to be tested, of the artificial neural network with the parameters associated with said epoch, in order to obtain a result matrix of the tested sub-image associated with said training epoch. Each coefficient of the result matrix of a tested sub-image may correspond to a defect probability of a pixel of the sub-image 201.

At the end of the fifth step 105, each pixel 2010 of the sub-image 201 is associated with a plurality of defect probabilities including at least one defect probability per epoch number selected.

A sixth step 106 of the method 100 according to the invention consists, for each sub-image 201 of the image to be tested, in merging result matrices of the sub-images tested, each result matrix of a tested sub-image resulting from the fifth step 105.

Merging is for example carried out by calculating the average of the coefficients of each result matrix corresponding to the sub-images tested, the result of merging being a matrix each coefficient of which is equal to or depends on the average of each coefficient with the same position of each result matrix of a sub-image tested.

At the end of the sixth step 106, a defect prediction is obtained for each sub-image 201 of the image 200 to be tested, corresponding to the probability that a defect is present in the sub-image 201. This probability is either given pixel per pixel (in the case of semantic segmentation), or given for the entire sub-image (in the case of classification).

An seventh, optional step 107 consists in reconstituting a result matrix of the tested image 200 by merging the result matrices of the sub-images 201 obtained at the end of the sixth step 106. In this case, the defect prediction is obtained for the image 200 to be tested, corresponding to the fact that a defect is present in the image 200. This probability is given pixel by pixel.

1. A method for detecting defect for an aeronautical part from at least one image to be tested of the aeronautical part subdivided into a plurality of sub-images, the method comprising:
supervisedly training, during a plurality of training epochs, an artificial neural network configured to provide a defect probability for each pixel of a training sub-image of a training image,
for each training epoch and for each image of a validation set, creating a defect probability matrix from merging defect probabilities determined for each pixel of each sub-image of the image of the validation set,
for each training epoch, determining, from the defect probability matrices associated with said training epoch, a defect detection curve as a function of false alarms,
determining an ensemble of the N best training epochs of the plurality of training epochs as a function of the defect detection curves as a function of false alarms and a criterion in the field, N being an integer greater than or equal to 1,
for each training epoch of the N best epochs, applying, to each sub-image of the image to be tested, the artificial neural network with parameters associated with said epoch, in order to obtain a tested sub-image associated with said training epoch, and
for each sub-image of the image to be tested, merging the result matrices of the N tested sub-images to obtain probabilities of the presence of defect on the sub-image.

2. The method according to claim 1, wherein the supervised training is carried out, for the plurality of epochs, from a training database, the number of training epochs of the plurality of training epochs being determined by a stop criterion, each training epoch of the plurality of training epochs being associated with a number, the training database comprising a plurality of sub-images for each image of a plurality of training images of aeronautical parts, each sub-image being associated with defect information for each pixel of the sub-image.

3. The method according to claim 1, wherein the step of creating a defect probability matrix associated with each training epoch and associated with each image of the validation set is carried out according to the following sub-steps of:
for each sub-image of the image of the validation set, using, on the sub-image, the artificial neural network with the parameters associated with said epoch, to obtain a defect probability for each pixel of the sub-image,
associating with each pixel of the image of the validation set, a pixel defect probability calculated from merging each defect probability obtained for the pixel.

4. The method according to claim 1, wherein the step of determining a defect detection curve as a function of false alarms associated with a training epoch is carried out according to the following sub-steps of:
for each threshold of a plurality of thresholds included in a predefined threshold interval, and for each image of the validation set:
thresholding the defect probability matrix associated with said image and with said epoch by the threshold;
for each ensemble of adjacent pixels of said image of the validation set comprising only pixels associated with a non-zero pixel defect probability in the thresholded defect probability matrix associated with the image:
if no pixel of the ensemble of pixels is associated with non-zero defect information in the validation set, incrementing a number of false alarms associated with the threshold;
for each ensemble of adjacent pixels with non-zero defect information in the validation set, if at least one pixel of the ensemble of pixels is associated with a non-zero pixel defect probability in the thresholded defect probability matrix, incrementing a number of detections associated with the threshold;
plotting a curve, associated with said epoch, representing the number of detections as a function of the number of false alarms, including one point per threshold, corresponding to the number of detections and to the number of false alarms associated with the threshold.

5. The method according to claim 1, wherein, for each training epoch from the ensemble of N best training epochs, the result of testing a sub-image is a matrix, each coefficient of which corresponds to a defect probability for each pixel of the sub-image.

6. The method according to claim 1, wherein the artificial neural network is configured to provide, from a sub-image, a defect probability per pixel of the sub-image, each sub-image of the training database and each sub-image of the validation database being associated with defect information per pixel of the sub-image.

7. The method according to claim 1, wherein the artificial neural network is configured so as to provide, from a sub-image, a defect probability for the ensemble of pixels of the sub-image, each sub-image of the training database and each sub-image of the validation database being associated with defect information for the ensemble of pixels of the sub-image.

8. The method according to claim 1, wherein the step of determining the defect detection curve further comprises a step of correcting by deleting each point corresponding to a threshold for which the number of false alarms associated with the threshold is less than the number of false alarms associated with the immediately following threshold in the interval of predefined thresholds following the plotting step, the deleting step being repeated for each deleted point starting from the lowest remaining threshold.

9. The method according to claim 8, wherein the corrected curve is normalised by adding an initial point associated with a zero number of detections and a zero number of false alarms and adding a final point associated with the maximum number of detections of the corrected curve and with a predefined maximum number of false alarms, following the correction step.

10. The method according to claim 2, wherein the criterion in the field for determining an ensemble of the N best training epochs of the plurality of training epochs as a function of the defect detection curves is the area under the curve.

11. The method according to claim 1, wherein each pixel of an image is associated with a position in the image and the step of creating the defect probability matrix for an image is further performed from the position associated with each pixel of the image.

12. The method according to claim 1, wherein upon creating the defect probability matrix for an image, merging is performed, for each pixel of the image associated with a plurality of defect probabilities, of the plurality of defect probabilities associated with the pixel.

13. The method according to claim 1, wherein the defect probabilities for each sub-image of the image to be tested obtained at the end of step are merged in order to obtain defect probabilities for the image to be tested.
